(19) United States
(12) Patent Application Publication
(10) Pub. No.: US 2010/0194134 A1
(43) Pub. Date: Aug. 5, 2010

(54) DEVICE FOR ADJUSTING A MOTOR VEHICLE SEAT AND MOTOR VEHICLE SEAT

(75) Inventors: Winfried Ehrhard, Munster (DE); Sven Stepan, Gross-Gerau (DE)

Correspondence Address: INGRASSIA FISHER & LORENZ, P.C. (GME), 7010 E. COCHISE ROAD, SCOTTSDALE, AZ, 85253, US

(73) Assignee: GM GLOBAL TECHNOLOGY OPERATIONS, INC., Detroit, MI (US)

(21) Appl. No.: 12/619,995

(22) Filed: Nov. 17, 2009

(30) Foreign Application Priority Data
Nov. 17, 2008 (DE) 102008057641.7

(51) Int. Cl. B60N 2/36; B60N 2/12; B60N 2/30

(52) U.S. Cl. 296/65.09; 297/341

(57) ABSTRACT

A motor vehicle is provided with a motor vehicle seat, a motor vehicle seat with a device and a device for adjusting a motor vehicle seat, more preferably of a motor vehicle back seat, with a seat cushion and with a backrest cushion, including, but not limited to a seat cushion holder on which the seat cushion of the motor vehicle seat is arranged. The device includes, but is not limited to a coupling device with means for transmitting a movement of the backrest cushion on to the seat cushion holder, so that folding of the backrest cushion in the direction of the seat cushion at least brings about one translation movement of the seat cushion holder away from the backrest cushion.

### CROSS-REFERENCE TO RELATED APPLICATION

This application claims priority to German Patent Application No. 102008057641.7, filed Nov. 17, 2008, which is incorporated herein by reference in its entirety.

### TECHNICAL FIELD

The invention relates to a device for adjusting a motor vehicle. The invention further relates to a motor vehicle seat, more preferably a motor vehicle back seat. In addition, the invention relates to a motor vehicle.

### BACKGROUND

Various motor vehicle back seats are known from the prior art which can be folded up in a space-saving manner by folding over the seat backrest and/or the seat cushion so that a larger stowage space is created behind the back seat.

From U.S. Pat. No. 6,375,255 B1 motor vehicle back seats are known for example which comprise folding mechanism. The folding mechanism comprises swivel joints in order to fold the seat backrest on to the seat cushion and to swivel the folded-up seat forward down into a free space.

It is at least one object to create a motor vehicle with a motor vehicle seat with a device for adjusting a motor vehicle seat which, subject to the formation of a flat loading floor, allows maximum flexibility, space-saving lowering even with confined space.

### SUMMARY

The invention includes, but is not limited to, the technical teaching that with a device for the adjusting of a motor vehicle seat, more preferably a motor vehicle back seat, with a seat cushion and a backrest cushion, comprising a seat cushion holder on which the seat cushion of the motor vehicle seat is arranged, is provided, that the device comprises a coupling device with means for transmitting a movement of the back seat cushion to the seat cushion holder, so that folding of the backrest cushion in direction of seat cushion brings about at least one translation movement of the seat cushion holder away from the backrest cushion. The motor vehicle seat usually comprises a seat cushion and a backrest cushion, wherein both seat cushion as well as backrest cushion can be arranged moveably about a joint. The device comprises a seat cushion holder on which the seat cushion is arranged. Usually the backrest cushions, which can likewise be mounted on suitable holders, are foldable about a swivel joint so that stowage space arranged behind the backrest cushion can be enlarged. Here, the backrest cushion can preferably be swiveled into the vehicle interior in a jointed manner, so that the backrest cushion back forms an extension of the stowage floor of the stowage space. Preferably the backrest cushion is swiveled in such a manner that backrest cushion back and stowage space floor are approximately located in one plane which more preferably is formed without steps. If the backrest cushion is swiveled on to the seat cushion the back side of the backrest cushion in conventional vehicles is not situated in a plane of the stowage floor. With confined space lowering of the seat cushion with folded-open backrest cushion is not possible, for example when a tank or a seat cushion restricts lowering. According to an embodiment of the invention, the backrest cushion is coupled with the seat cushion holder via a coupling device in order to simultaneously bring about a movement of the seat cushion when folding the backrest cushion so that space is created for folding over of the backrest cushion, which can at least partially be arranged in the space created. The coupling device therefore comprises means for transmitting a movement of the backrest cushion, more preferably folding movement, on to the seat cushion holder. Upon folding of the backrest cushion in direction of seat cushion holder the seat cushion holder and thus also the seat cushion, which is arranged on the seat cushion holder, is moved, so that the additional space gain for the stowage of the backrest cushion is formed. This is more preferably achieved in that folding of the backrest cushion in the direction of seat cushion brings about at least one translation movement of the seat cushion holder away from the backrest cushion. In addition, another movement can also be executed, for example an additional rotary movement.

In an embodiment of the present invention it is provided that the means comprise a swivel-slide bearing unit in order to bring about a swivel-slide movement of the seat cushion holder upon the folding of the back seat cushion. The coupling device comprises a swivel joint device with which the seat cushion holder is coupled with the backrest cushion. In this manner it is guaranteed that the seat cushion holder in addition to a swivel movement additionally performs a sliding movement and additional space for the folding of the backrest cushion is thus created. The swivel-slide bearing unit can for example comprise a plurality of swivel-slide bearings which can be arranged at appropriate ends of the seat holder.

In another embodiment of the present invention it is provided that the means at least comprise a rigid connecting part which couples the back seat cushion with a seat holder in order to transmit folding movement of the back seat cushion on to the seat cushion holder. Preferably the rigid connecting part is embodied as bar or rod and connects the backrest cushion with a seat holder. In this manner, during folding of the backrest cushion direct coupling with the seat cushion holder can be created so that the folding movement can be transmitted on to the seat holder and a slide and/or swivel-slide movement can be realized. The rigid connecting part can be curved so that it does not impair a user of the seat. A plurality of connecting parts can be provided at the lateral edges of the back seat.

In yet another embodiment of the present invention it is provided that a swivel joint device for the swiveling of the seat cushion holder is arranged in a front region of the seat cushion holder so that upon a shifting to the front the seat cushion holder via the swivel joint device can be simultaneously swiveled forward down. Because of this, when folding the backrest cushion, the seat cushion with the seat cushion holder is pushed forward and a swivel movement about the swivel joint device is simultaneously executed. In this manner, additional free space for the folding-in of the back seat cushion is created.

In yet another embodiment of the present invention it is provided that the swivel-slide bearing unit is arranged in a rear region of the seat cushion holder. The swivel-slide bearing unit arranged in the region of the back seat cushion brings about a translation movement of the seat cushion holder upon folding of the backrest cushion. In that the bearing unit is embodied also in a manner capable of being swiveled a swivel movement about the swivel joint device can be additionally executed in addition to the sliding movement.

Yet a further embodiment of the present invention provides that the connecting part is rotatably arranged on the seat cushion holder in order to make possible folding of the backrest cushion substantially as far as into a plane of the seat cushion. The connecting part which is rigid in itself is rotatably connected with the seat cushion holder and/or the backrest cushion about a corresponding joint. Thus, even with different angles, effective force transmission can still take place which makes possible at least a translatoric movement of the seat cushion.

Yet a further embodiment of the present invention provides that at least one guide for the guiding of the swivel-slide bearing unit is provided which makes possible moving the seat cushion holder in accordance with the neighboring support structure. The guide can for example be designed as guide rail or guide rail pair which are designed parallel and equidistant to each other and make possible movement of the seat cushion holder along the guide. The slide bearing is suitably coupled with the guide in order to perform a sliding movement. The guide can be adapted to the support structure so that for example a narrow space is utilized as best as possible through suitably adapted guidance. For example the support structure can be a vehicle floor which for example covers a motor vehicle tank.

In yet another embodiment of the present invention it is provided that at least one locking device is provided in order to securely hold the seat cushion holder and/or the back seat rest in a predeterminable position. More preferably in a user position, in which the seat cushion and backrest cushion are arranged approximately L-shaped, the components have to be suitably secured in order to prevent unintentional movement of the components. Through suitable actuation mechanisms the locking device can be released and folding of the back seat rest and thus a sliding-swivel movement of the seat cushion holder realized.

The embodiments of the invention additionally include the technical teaching that with a motor vehicle seat, more preferably a motor vehicle back seat, with a seat cushion arranged on a seat cushion holder and a foldably mounted back seat cushion, which following the release of an unlocking device is foldable in the direction of a seat cushion, it is provided that the motor vehicle seat comprises at least one device according to an embodiment of the invention in order to bring about, during the folding of the back seat cushion, a translation movement of the seat holder with the seat cushion coupled with this. Through the device a coupled swivel-translation movement of the seat cushion holder with seat cushion is possible. A plurality of motor vehicle seats can be provided each of which comprises a corresponding device. A motor vehicle seat can also be designed as a motor vehicle back seat bench which is divisible, for example asymmetrically in a ratio of 60:40.

The embodiments of the invention also include the technical teaching that with a motor vehicle with at least one support structure it is provided that at least one motor vehicle seat according to an embodiment of the invention coupled with the support structure is provided. The support structure can be a motor vehicle floor or corresponding carrier of a motor vehicle. A plurality of motor vehicle seats, more preferably motor vehicle back seats can be provided, for example a split or non-split back seat bench.

Further measures improving the invention are stated in the claims and are obtained from the following description of exemplary embodiments of the invention which are schematically shown in the figures. For same or similar components or features, uniform reference symbols are used here. Features or components of different embodiments can be combined so as to obtain additional embodiments. All features and/or advantages including design details, spatial arrangements and method steps emanating from the claims the descriptions or drawings can be substantial to the invention by themselves as well as in the most diverse combinations.

### BRIEF DESCRIPTION OF THE DRAWINGS

The present invention will hereinafter be described in conjunction with the following drawing figures, wherein like numerals denote like elements, and:

FIG. 1 schematically in a perspective view a motor vehicle seat without cushion, with a device for the adjusting of the motor vehicle seat according to the invention;

FIG. 2 enlarged a detail A of FIG. 1 with swivel joint device;

FIG. 3 an enlarged detail B according to FIG. 1 with a seat cushion holder in two different positions;

FIG. 4 the motor vehicle seat according to FIG. 1 with cushion;

FIG. 5 schematically in a perspective view the motor vehicle seat according to FIG. 4 in a folded or retracted position; and

FIG. 6 a lateral view of the motor vehicle seat according to FIG. 4 and FIG. 5, both in a user position as well as in a retracted position with respect to a motor vehicle device.

### DETAILED DESCRIPTION

The following detailed description is merely exemplary in nature and is not intended to limit application and uses. Furthermore, there is no intention to be bound by any theory presented in the preceding background or summary or the following detailed description.

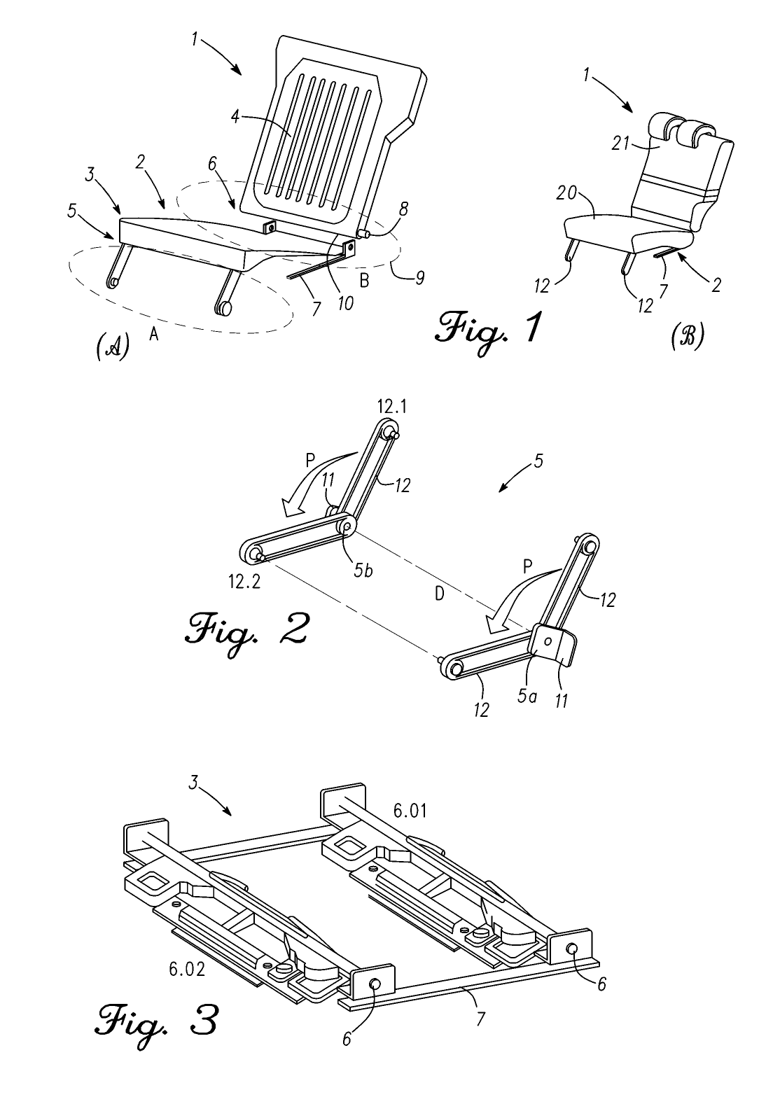

FIG. 1 schematically shows a motor vehicle seat 1 in a perspective view, for better understanding of the construction once without seat cushion (FIG. 1a) and once with seat cushion (FIG. 1b). The motor vehicle seat 1 is embodied with a device 2 for the adjusting of the motor vehicle seat 1. The motor vehicle seat 1 is embodied as back seat. It comprises a seat cushion 20 and a backrest cushion 21 which are arranged on corresponding holders—a seat cushion holder 3 and a backrest cushion holder 4. The seat cushion holder 3, which is embodied in a frame structure, at a front section (approximately in the section A) comprises a swivel joint device 5, which in FIG. 2 is shown in a more detailed manner and via the seat cushion holder 3 is connected with a support structure (not shown here), for example of a motor vehicle, in a manner capable of being swiveled. On the opposite section at B the seat cushion holder 3 has a swivel-slide bearing unit 6 which is described in more detail in FIG. 3. The swivel-slide bearing unit 6 serves to move the seat cushion holder 3 both translatorically as well as rotatorically upon appropriate effect of force. The swivel-slide bearing unit 6 is coupled with a guide 7 which in FIG. 1 is embodied as rail guide. The swivel-slide bearing unit 6 can be moved along the guide 7.

The backrest cushion 21 can be attached to the backrest cushion holder 4. The backrest cushion holder 4 is mounted on a joint 8 for folding the entire backrest with backrest cushion 21 and backrest cushion holder 4, which joint is preferably embodied as swivel joint. Following unlocking of the backrest the backrest cushion holder 4 including backrest cushion 21 can be swiveled about this joint 8 in the direction of the seat cushion so that it can be folded up in a compact manner and if applicable correspondingly enlarge a stowage space arranged behind the back seat. The device 2 comprises a coupling device 9 in order to couple the backrest with the seat, comprising the seat cushion 20 and the seat cushion holder 3. To this end, the coupling device 9 comprises suitable means by means of which a movement of the foldable backrest can be transmitted to the seat so that folding of the backrest cushion 21 in the direction of the seat cushion 20 at least brings about a translation movement of the seat cushion holder 3 away from the backrest cushion 21. The means among other things comprise the swivel-slide bearing unit 6 and a rigid connecting part 10 which via joints, more preferably rotary joints, is arranged on the backrest and the seat, more exactly on the corresponding cushion holders 3, 4.

FIG. 2 shows enlarged a detail A of FIG. 1 in which the swivel joint device 5 is shown in more detail. The swivel joint device 5 comprises two swivel bearings 5a, 5b arranged spaced from each other, which are inched for example on a support structure 11, for example a motor vehicle floor or the like. The swivel bearings 5a, 5b are connected with the seat cushion holder 3 (not shown here) via levers 12 so that the seat cushion holder 3 via the levers 12 is rotatably mounted about an axis of rotation D of the swivel joint device 5 and accordingly can be swiveled about the axis of rotation D as indicated by the arrows P. The levers 12 are shown in FIG. 2 in a first position 12.1, in which the motor vehicle seat 1 is arranged in a user position, and in a second position 12.2, in which the motor vehicle seat 1 is arranged in a folded-up state, so that the adjusting movement about the swivel joint device 5 becomes clear.

FIG. 3 shows enlarged a detail B according to FIG. 1 with the seat cushion holder 3 in two different positions, a user position 6.01 and a folded-in position 6.02. The seat cushion holder 3 is slidably guided along a guide 7 via the swivel-slide bearing unit 6. In addition to a slide bearing the swivel-slide bearing unit 6 also comprises a swivel bearing, so that the seat cushion holder 3 is slidably and swivelably mounted at the same time, as is evident in the position 6.02.

FIG. 4 shows the motor vehicle seat 1 according to FIG. 1 with cushion, once showing the seat cushion holders 3, 4 (FIG. 4a) and once without the holders (FIG. 4b). The motor vehicle seat 1 is embodied with the seat cushion 20 arranged on the seat cushion holder 3 and the backrest cushion 21 arranged on the backrest cushion holder 4. In FIG. 4a and FIG. 4b the motor vehicle seat 1 is arranged in an operating position, in which the seat and the backrest are arranged substantially L-shaped relative to each other, so that a user is able to sit on the motor vehicle seat 1. If unlocking of the backrest is now performed the backrest can be swiveled about the joint 8 in the direction of the seat according to arrow P1. In doing so, the rigid connecting part 10 transmits the movement and the concomitant force from the backrest on to the seat cushion holder 3. The seat cushion holder 3 is translatorically moved to the front away from the backrest by means of the swivel-slide bearing unit 6 along the guide 7 and simultaneously swiveled forward about the swivel joint device 5 and the levers 12 arranged thereon, as indicated by the arrows P2 and P3 respectively.

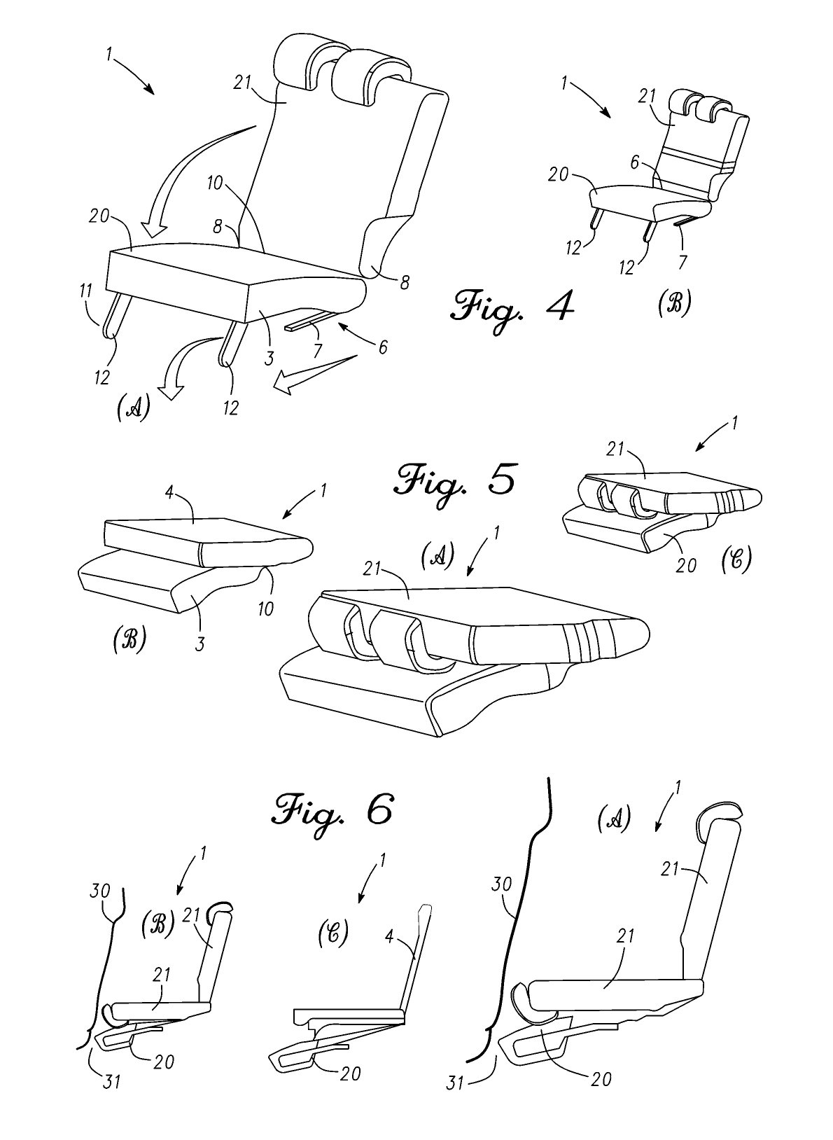

FIG. 5 schematically shows the motor vehicle seat 1 according to FIG. 4 in a perspective view in a folded (in) or retracted position once with seat cushion (20, 21) and seat cushion holders (3, 4) (FIG. 5a), once with seat cushion holders (3, 4) without seat cushions (20, 21) (FIG. 5b) and once with seat cushions (20, 21) without seat cushion holders (3, 4) (FIG. 5c). In the FIGS. 5a to 5c the seat is arranged shifted to the front and folded forward. The backrest rests on the seat. Through the movement of the seat away from the backrest a corresponding space is created which is utilized for the space-saving accommodation of at least one part of the backrest.

FIG. 6 shows a lateral view of the motor vehicle seat 1 according to FIG. 4 and FIG. 5, both in a user position as well as in a retracted position with regard to a motor vehicle installation, wherein in FIG. 6a the motor vehicle seat 1 is shown with seat cushion (20, 21) and seat cushion holders (3, 4), in FIG. 6b with seat cushions (20, 21) without seat cushion holders (3, 4) and in FIG. 6c with seat cushion holders (3, 4) without seat cushions (20, 21). In FIG. 6 a front seat 30 and a free space 31 embodied as footwell is shown. The backrest is used from a user position into a folded-in position. As is evident in FIG. 6 the motor vehicle seat 1 including seat cushion 20 and seat cushion holder 4 is moved in a coupled state from a user position into a position in the free space 31. In the folded-in position the backrest is arranged approximately in the position in which the seat found itself in the user position. In this manner the space available in a motor vehicle is optimally utilized so that a preferably large stowage space can be created behind the back seat.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A device for the adjusting of a motor vehicle seat with a seat cushion and with a backrest cushion, comprising:
a seat cushion holder on which the seat cushion of the motor vehicle seat is arranged; and
a coupling device with a means for transmitting a movement of the backrest cushion on to the seat cushion holder, so that folding of the backrest cushion in a direction of the seat cushion is adapted to at least bring about one translation movement of the seat cushion holder away from the backrest cushion.

2. The device according to claim 1, wherein the means for transmitting the movement of the backrest cushion comprises a swivel-slide bearing unit in order to bring about a swivel-slide movement of the seat cushion holder during the folding of the backrest cushion.

3. The device according to claim 1, wherein the means for transmitting the movement of the backrest cushion comprises at least one rigid connecting part that couples the backrest cushion with the seat cushion holder in order to transmit a folding movement of the backrest cushion on to the seat cushion holder.

4. The device according to claim 1, further comprising a swivel joint device for the swiveling of the seat cushion holder that is arranged in a front region of the seat cushion holder so that upon sliding to the front the seat cushion holder via the swivel joint device can be simultaneously swiveled forward down.

5. The device according to claim 2, wherein the swivel-slide bearing unit is arranged in a rear region of the seat cushion holder.

6. The device according to claim 3, wherein the at least one rigid connecting part is rotatably arranged on the seat cushion holder in order to make possible folding of the backrest cushion substantially as far as in to a plane of the seat cushion.

7. The device according to claim 2, further comprising at least one guide for guiding the swivel-slide bearing unit that makes possible moving of the seat cushion holder according to a neighboring support structure.

8. The device according to claim 1, further comprising at least one locking device in order to securely hold at least one of the seat cushion holder in a predeterminable position.

9. A motor vehicle seat, comprising:
a seat cushion arranged on a seat cushion holder and a foldably mounted backrest cushion, which after releasing an unlocking device can be folded in a direction of the seat cushion;
a device for the adjusting of the motor vehicle seat with the seat cushion and with a backrest cushion, the device comprising:
a coupling device with a means for transmitting a movement of the backrest cushion on to the seat cushion holder, so that folding of the backrest cushion in the direction of the seat cushion is adapted to at least bring about one translation movement of the seat cushion holder away from the backrest cushion.

10. The motor vehicle seat according to claim 9, wherein the means for transmitting the movement of the backrest cushion comprises a swivel-slide bearing unit in order to bring about a swivel-slide movement of the seat cushion holder during the folding of the backrest cushion.

11. The motor vehicle seat according to claim 9, wherein the means for transmitting the movement of the backrest cushion comprises at least one rigid connecting part that couples the backrest cushion with the seat cushion holder in order to transmit a folding movement of the backrest cushion on to the seat cushion holder.

12. The motor vehicle seat according to claim 9, further comprising a swivel joint device for the swiveling of the seat cushion holder that is arranged in a front region of the seat cushion holder so that upon sliding to the front the seat cushion holder via the swivel joint device can be simultaneously swiveled forward down.

13. The motor vehicle seat according to claim 10, wherein the swivel-slide bearing unit is arranged in a rear region of the seat cushion holder.

14. The motor vehicle seat according to claim 11, wherein the at least one rigid connecting part is rotatably arranged on the seat cushion holder in order to make possible folding of the backrest cushion substantially as far as in to a plane of the seat cushion.

15. The motor vehicle seat according to claim 10, further comprising at least one guide for guiding the swivel-slide bearing unit that makes possible moving of the seat cushion holder according to a neighboring support structure.

16. The motor vehicle seat according to claim 9, further comprising at least one locking device in order to securely hold at least one of the seat cushion holder in a predeterminable position.

17. A motor vehicle, comprising:
a support structure;
a motor vehicle seat coupled with the support structure, the motor vehicle seat comprising:
a seat cushion arranged on a seat cushion holder and a foldably mounted backrest cushion, which after releasing an unlocking device can be folded in a direction of the seat cushion, comprising a device for the adjusting of the motor vehicle seat with the seat cushion and with a backrest cushion; and
a coupling device with a means for transmitting a movement of the backrest cushion on to the seat cushion holder, so that folding of the backrest cushion in the direction of the seat cushion at least brings about one translation movement of the seat cushion holder away from the backrest cushion.

18. The motor vehicle according to claim 17, wherein the means for transmitting the movement of the backrest cushion comprises a swivel-slide bearing unit in order to bring about a swivel-slide movement of the seat cushion holder during the folding of the backrest cushion.

19. The motor vehicle according to claim 17, wherein the means for transmitting the movement of the backrest cushion comprises at least one rigid connecting part that couples the backrest cushion with the seat cushion holder in order to transmit a folding movement of the backrest cushion on to the seat cushion holder.

20. The motor vehicle according to claim 17, further comprising a swivel joint device for the swiveling of the seat cushion holder that is arranged in a front region of the seat cushion holder so that upon sliding to the front the seat cushion holder via the swivel joint device can be simultaneously swiveled forward down.

21. The motor vehicle according to claim 18, wherein the swivel-slide bearing unit is arranged in a rear region of the seat cushion holder.

22. The motor vehicle according to claim 19, wherein the at least one rigid connecting part is rotatably arranged on the seat cushion holder in order to make possible folding of the backrest cushion substantially as far as in to a plane of the seat cushion.

23. The motor vehicle according to claim 18, further comprising at least one guide for guiding the swivel-slide bearing unit that makes possible moving of the seat cushion holder according to a neighboring support structure.

24. The motor vehicle according to claim 17, further comprising at least one locking device in order to securely hold at least one of the seat cushion holder in a predeterminable position.
